(19) United States
(12) Patent Application Publication
(10) Pub. No.: US 2004/0257555 A1
(43) Pub. Date: Dec. 23, 2004

(54) Distance measuring sensor and electronics equipped therewith

(76) Inventors: Takashi Takaoka, Kitakatsuragi-gun (JP); Shinya Kawanishi, Tenri-shi (JP)

Correspondence Address: BIRCH STEWART KOLASCH & BIRCH, PO BOX 747, FALLS CHURCH, VA, 22040-0747, US

(21) Appl. No.: 10/872,476

(22) Filed: Jun. 22, 2004

(30) Foreign Application Priority Data
Jun. 23, 2003 (JP) 2003-178412

(51) Int. Cl. G01C 3/00; G01C 3/08; G01C 5/00; G03B 7/099; G02B 7/28; G03B 13/00

(52) U.S. Cl. 356/3.01

(57) ABSTRACT

A distance measuring sensor includes an LED emitting light, a projection lens receiving the light from the LED to direct the light to illuminate an object, a light receiving lens collecting light reflected by the object, and a PSD receiving at a location light collected by the light receiving lens to output a signal corresponding to the location. The light receiving lens and the PSD are configured to have an adjustable distance therebetween, as seen along an optical axis from the light receiving lens to the PSD. A distance measuring device and electronics equipped therewith can thus be obtained that can rapidly provide information on a distance of an object over a wide range and be configured of a reduced number of components.

This nonprovisional application is based on Japanese Patent Application No. 2003-178412 filed with the Japan Patent Office on Jun. 23, 2003, respectively, the entire contents of which are hereby incorporated by reference.

### BACKGROUND OF THE INVENTION

1. Field of the Invention

The present invention relates to distance measuring sensors capable of directing light to illuminate an object and receiving a reflection of light from the object to obtain information on the object's distance, and electronics equipped with the sensor.

2. Description of the Background Art

As a device outputting information on an object's distance a distance measuring sensor utilizing so-called triangulation is known.

With reference to FIG. 10, a conventional distance measuring sensor 101 includes a light emitting diode (LED) 102, a projection lens 103, a light receiving lens 104, a semiconductor position sensitive photodetector (PSD) 105, and an IC 106. LED 102, PSD 105, and IC 106 are for example die-bonded or wire-bonded and thus mounted on a lead frame 108. They are surrounded by a translucent resin 109 as they molded thereby. Furthermore, translucent resin 109 is externally molded by a casing 107 formed of a shading resin. Casing 107 has an upper surface having projection lens 103 and light receiving lens 104 arranged thereon opposite LED 102 and PSD 105, respectively.

A distance measuring sensor having a conventional triangulation applied thereto utilizes a principle to measure an object's distance, as described hereinafter.

With reference to FIG. 11, LED 102 emits light which is in turn collected by projection lens 103 to illuminate an object located for example at a location 151, 152. The object reflects scattered light which is in turn collected by light receiving lens 104 and received by PSD 105. PSD 105 receives a reflection of light at a location (a spot location), which varies with the object's distance from distance measuring sensor 101. PSD 105 outputs from opposite ends a pair of photocurrents corresponding to the location that receives light. Form this output, IC 106 (FIG. 10) outputs information on the object's distance.

However, distance measuring sensor 101 can only obtain information on an object's distance for a positional range limited for example to locations 151-152 allowing PSD 105 to receive a reflection of light. As such, information on the object's distance is obtained for a disadvantageously limited positional range. Information on an object's distance is obtained for a positional range having a length L (a distance measurement allowing range L) determined from triangulation's principle by the following expression:

$$X = \frac{A \times f}{L} \qquad ( 1 )$$

wherein X represents a spot's positional range detectable by the PSD, A represents a length of a baseline of the projection lens and the light receiving lens (a distance from the position of an aperture of the projection lens to that of an aperture of the light receiving lens), and f represents a distance between the light receiving lens and the PSD as seen along an optical axis. From this expression it can be understood that smaller ranges X allow larger lengths L. Reduced range X, however, reduces distance measuring sensor 101 in precision. This method can only increase range L by a limited length.

Accordingly in order to maintain a distance measuring sensor's measurement precision while providing increased range L it has been necessary to provide an LED and a PSD for close range and an LED and a PSD for long range, and two processors outputting distance information based on a signal output from each PSD. This arrangement, however, disadvantageously requires a significantly increased number of components.

Furthermore, a distance measuring sensor may include a single LED and a plurality of PSDs. In this arrangement, however, the plurality of PSDs can simultaneously receive light. As such, waves of light interfere with each other and the sensor's precision is impaired. Furthermore, a distance measuring sensor may include a plurality of LEDs and a single PSD. In this arrangement, however, the LEDs emit their respective beams of light, which can simultaneously be received by the single PSD. As such, waves of light interfere with each other and the sensor's precision is impaired. To prevent the distance measuring sensor from having reduced precision, the plurality of LEDs or PSDs must be driven, one at a time, so that for each case, distance information is output as based on the PSD's output. This is disadvantageous as information on an object's distance cannot rapidly be obtained.

### SUMMARY OF THE INVENTION

The present invention contemplates a distance measuring sensor including a smaller number of components and capable of rapidly obtaining information on a distance of an object over a wide range, and electronics equipped with the sensor.

The present invention in one aspect provides a distance measuring sensor including: a light emitting device; a projection lens receiving light emitted from the light emitting device to direct the light to illuminate an object; a light receiving lens collecting light reflected by the object; and a photoreceptive device receiving at a location light collected by the light receiving lens to output a signal corresponding to the location. The light receiving lens and photoreceptive device are configured to have a distance therebetween adjustable in length, as seen along an optical axis from the light receiving lens to the photoreceptive device.

In the present distance measuring sensor in one aspect the light receiving lens and the photoreceptive device can have a distance therebetween adjustable to change the sensor's measurement range and distance measurement allowing range. Changing the sensor's measurement range and distance measurement allowing range, and outputting information on an object's distance for the changed measurement range as well as the changed distance measurement allowing range allows an increased distance measurement allowing range of the sensor. Furthermore, the information of the object's distance can be output without the necessity of driving a plurality of LEDs or photoreceptive devices separately. As such the Information can rapidly be obtained for a wide range. As a plurality of LEDs and photoreceptive devices and a processor can be dispensed with, the sensor can be configured of a reduced number of components.

Note that throughout the specification an “optical axis” means an optical axis of light directed from the projection lens to an object.

The present invention in another aspect provides a distance measuring sensor including: a light emitting device; a projection lens receiving light emitted from the light emitting device to direct the light to illuminate an object; a light receiving lens collecting light reflected by the object; and a photoreceptive device receiving at a location light collected by the light receiving lens to output a signal corresponding to the location. The projection leans and the light receiving lens are configured to provide a baseline adjustable in length.

In the present distance measuring sensor in another aspect the projection lens and light receiving lens can provide a baseline adjustable in length to change the sensor's measurement range and distance measurement allowing range. Changing the sensor's measurement range and distance measurement allowing range, and outputting information on an object's distance for the changed measurement range as well as the changed distance measurement allowing range allows an increased distance measurement allowing range of the sensor. Furthermore, the distance can be measured without the necessity of driving a plurality of LEDs or photoreceptive devices separately. Information on a distance of an object can rapidly be obtained for a wide range. As a plurality of LEDs and photoreceptive devices and an IC can be dispensed with, the sensor can be configured of a reduced number of components.

The present invention in still another aspect provides a distance measuring sensor including: a light emitting device; a projection lens receiving light emitted from the light emitting device to direct the light to illuminate an object; a light receiving lens collecting light reflected by the object; and a photoreceptive device receiving at a location light collected by the light receiving lens to output a signal corresponding to the location. The light receiving lens has first and second apertures.

In the distance measuring sensor in still another aspect a reflection of light collected by a first aperture and a reflection of light collected by a second aperture are received by a photoreceptive device. Thus information on the presence/absence of an object can be obtained for a measurement range corresponding to a measurement range associated with the first aperture plus that associated with the second aperture. Furthermore, measurement can be done without driving a plurality of LEDs or photoreceptive devices separately or moving the light receiving lens. Information on a distance of an object can further rapidly be obtained for a wide range. Furthermore, a plurality of LEDs, photoreceptive devices and an IC can be dispensed with, and the sensor can be formed of a reduced number of components.

In the present sensor preferably the first and second apertures are arranged in a single plane perpendicular to an optical axis.

This can prevent light passing through the first aperture from entering the second aperture. This can in turn prevent light entering the first aperture and that entering the second aperture from interfering with each other and resulting in erroneous measurement.

In the present sensor preferably the light receiving lens includes a first light receiving lens having the first aperture and a second light receiving lens having the second aperture.

As the light receiving lens has the first and second apertures configured by separate lenses, light having entered the first aperture can be prevented from leaking and interfering with that having entered the second aperture (or producing stray light).

Preferably the present sensor further includes a shading member arranged between the first and second apertures.

The shading member isolates light having entered the first aperture and that having entered the second aperture. The light having entered the first aperture can further be prevented from leaking and interfering with that having entered the second aperture (or producing stray light).

The present invention provides electronics equipped with the distance measuring sensor as described above. The distance measuring sensor is applicable to a variety of electronics and can be used in a variety of applications.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a schematic cross section of a distance measuring sensor of the present invention in a first embodiment;

FIG. 2 is a schematic view for illustrating a principle applied in the present sensor of the first embodiment to measure an object's distance;

FIG. 3 represents in the first embodiment a relationship between a distance from an object to the sensor and a photocurrent output from a PSD;

FIG. 4 is a schematic cross section of the present sensor in a second embodiment;

FIG. 5 is a schematic view for illustrating a principle applied in the present sensor of the second embodiment to measure an object's distance;

FIG. 6 is a schematic cross section of the present sensor in a third embodiment;

FIG. 7 is a schematic view for illustrating a principle applied in the present sensor of the third embodiment to measure an object's distance;

FIG. 8 represents in the third embodiment a relationship between a distance from an object to the sensor and a photocurrent output from a PSD;

FIG. 9 is a schematic cross section of the present sensor in a fourth embodiment;

FIG. 10 is a cross section of a conventional distance measuring sensor's structure employing triangulation; and

FIG. 11 is a schematic view for illustrating a principle applied in a conventional distance measuring sensor employing triangulation to measure an object's distance.

### DESCRIPTION OF THE PREFERRED EMBODIMENTS

Hereinafter the present invention in embodiments will be described with reference to the drawings.

### First Embodiment

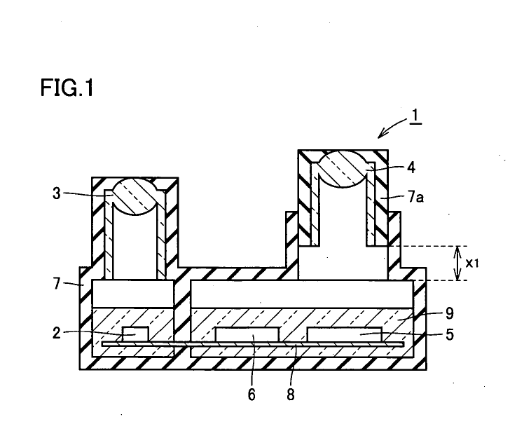

With reference to FIG. 1, a distance measuring sensor 1 includes a light emitting device (LED) 2, a projection lens 3, a light receiving lens 4, a PSD 5 (a photoreceptive device), and an IC 6 (a processor). LED 2, IC 6 and PSD 5 are arranged on a lead frame 8, and mounted for example by die-bonding, wire-bonding or the like. LED 2, and IC 6 and PSD 5 are isolated by a casing 7. Furthermore, LED 2, IC 6 and PSD 5 are surrounded by and thus covered with translucent resin 9 so that they are fixed in casing 7.

Projection lens 3 is fixed in casing 7 at an upper left protrusion, as seen in the figure. Light receiving lens 4 is fixed in an upper right casing 7a, as seen in the figure, secured to casing 7 for example by a gear (not shown). As the gear or the like rotates, casing 7a can be moved parallel to an optical axis (vertically as seen in the figure) within a range x₁ with light receiving lens 4 held thereby.

In the present embodiment distance measuring sensor 1 measures an object's distance in accordance with a principle as described hereinafter.

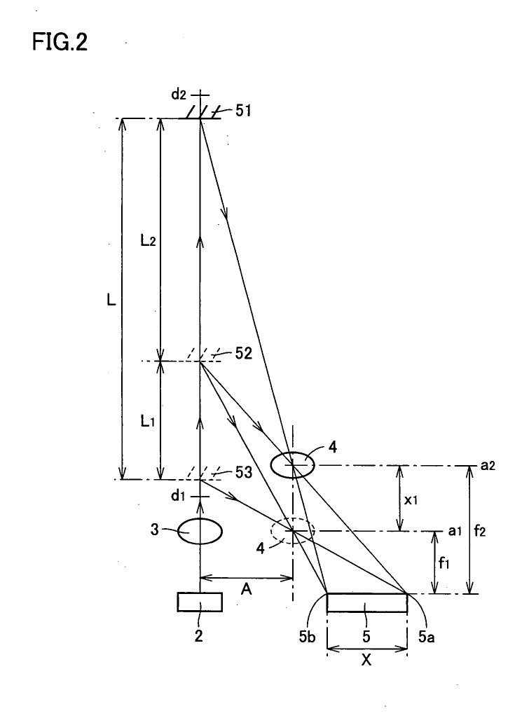

With reference to FIG. 2, LED 2 emits light which is in turn collected by projection lens 3 and directed to illuminate an object present for example at a location 51-53. The object provides a reflection of light which is in turn collected by light receiving lens 4 and received by PSD 5.

PSD 5 receives a reflection of light at a location, which varies with a distance from distance measuring sensor 1 to the object. PSD 5 outputs from opposite ends 5a and 5b a pair of photocurrents corresponding to the location that receives light. From this output, IC 6 (FIG. 1) obtains information on the object's distance and outputs it. In FIG. 2, a distance A indicates a distance from projection lens 3 to light receiving lens 4 (a length of a baseline), and a length X indicates a positional range of a spot detectable by PSD 5.

In the present embodiment distance measuring sensor 1 is configured to allow light receiving lens 4 and PSD 5 to have an adjustable distance therebetween, as seen along an optical axis from light receiving lens 4 to PSD 5. More specifically, light receiving lens 4, as seen in FIG. 2, can be moved vertically within range x₁. If light receiving lens 4 has a position a₁ closest within range x₁ to PSD 5, light receiving lens 4 will have a distance f₁ to PSD 5, as seen along the optical axis. If light receiving lens 4 has a position a₂ remotest within range x₁ from PSD 5 then light receiving lens 4 will have a distance f₂ to PSD 5, as seen along the optical axis. Light receiving lens 4 and PSD 5 are thus arranged to have a distance therebetween, as seen along an optical axis from light receiving lens 4 to PSD 5, adjustable from distance f₁ to distance f₂.

More specifically, if light receiving lens 4 has position a₁, distance measuring sensor 1 has a distance measurement allowing range L₁ satisfying X=(A×f₁)/L₁, and IC 6 (FIG. 1) can output information on a distance of an object present within a range from location 51 to location 52. Furthermore, if light receiving lens 4 has position a₂ distance measuring sensor 1 has a distance measurement allowing range L₂ satisfying X=(A×f₂)/L₂, and IC 6 can output information on a distance of an object present within a range from location 52 to location 53. As such, arranging light receiving lens 4 at each of positions a₁ and a₂ an outputting an object's positional information for each position allows distance measuring sensor 1 to have a range L₁+L₂=L to provide an increased distance measurement allowing range.

Positions a₁ and a₂ are determined, for example as described hereinafter, so that a reflection of light from a single object that passes thorough lens 4 having position a₁ and that of light from the object that passes thorough lens 4 having position a₂ are not redundantly received to provide a reduced distance measurement allowing range.

Initially, a closest position (e.g., position 53) is determined within a positional range from which an observer desires to obtain an object's positional information. The object is arranged at the position, and a position for light receiving lens 4 that allows a reflection of light from the object to illuminate PSD 5 at one end 5a (a right end as seen in FIG. 2) is determined as position a₁. Then, with light receiving lens 4 fixed at position a₁, a position (e.g., position 52) for the object that allows a reflection of light from the object to illuminate PSD 5 at the other end b (a left end as seen in FIG. 2) is examined. Then, with the object having a position (e.g., position 52) that allows a reflection of light to illuminate PSD 5 at the other end 5b, a position for light receiving lens 4 that allows a reflection of light from the object to illuminate PSD 5 at one end 5a (the right end as seen in FIG. 2) is determined as position a₂.

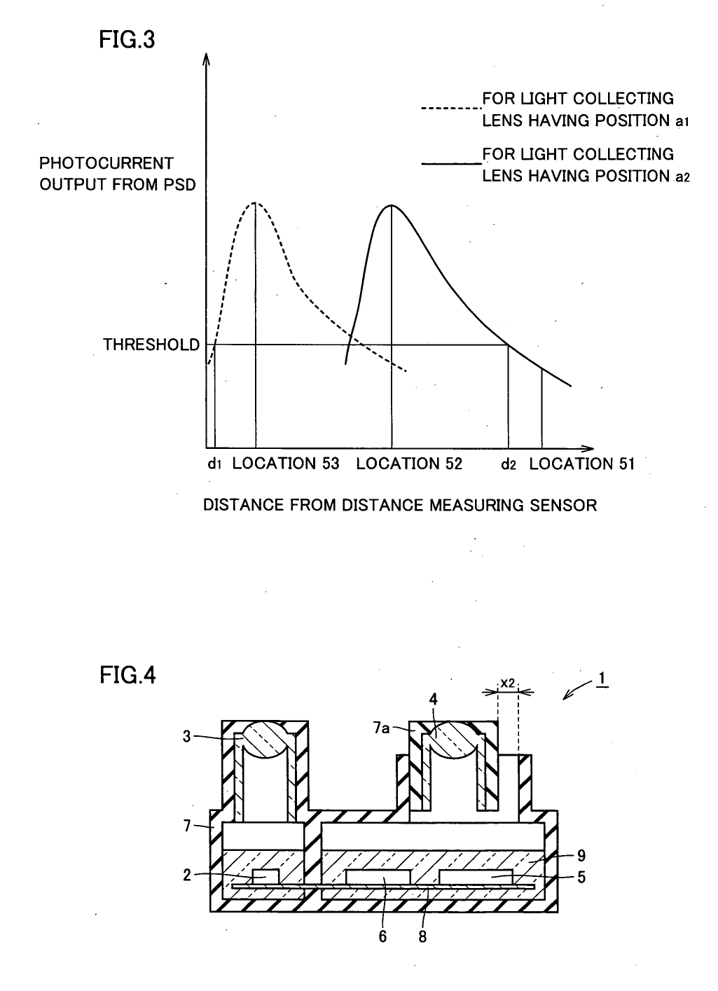

With reference to FIG. 3, when light receiving lens 4 has position a₁ for example PSD 5 outputs from one end 5a a photocurrent having a curve as indicated in FIG. 3 by a dotted line. More specifically, when the object has position 53 PSD 5 receives at one end 5a a largest quantity of light and outputs a maximized photocurrent. As the object is moved away to be farther than position 53, PSD 5 receives at one end 5a a gradually reducing quantity of light and also outputs a gradually reducing photocurrent. By contrast, when the object is closer than position 53, PSD 5 does not receive a reflection of light. Accordingly PSD 5 outputs a rapidly decreasing photocurrent at one end 5a.

By contrast, when light receiving lens 4 has position a₂ PSD 5 outputs from one end 5a a photocurrent represented by a curve indicated in FIG. 3 by a solid line. More specifically, when an object has position 52 the PSD 5 receives at one end 5a a largest quantity of light and outputs a maximized photocurrent, and as the object is moved away to be farther than position 52 PSD 5 receives at one end 5a a gradually decreasing quantity of light and accordingly outputs a gradually decreasing photocurrent. By contrast, when the object is closer than position 52, PSD 5 does not receive a reflection of light. Accordingly PSD 5 outputs a rapidly decreasing photocurrent at one end 5a.

PSD 5 also outputs at the other end 5b a photocurrent similar to that output from PSD 5 at one end 5a. IC 6 (FIG. 1) is driven by theses two photocurrents output to output information on the object's distance. The information on the object's distance for example means a distance from distance measuring sensor 1 to the object, the presence/absence of the object within a fixed detection range, and the like.

If IC 6 is adapted to output information on whether an object is present or absent within a fixed detection range a threshold is set for a photocurrent output from PSD 5 at one end 5a. If one end 5a outputs a photocurrent larger than the threshold IC 6 outputs information that an object is present and if one end 5a outputs a photocurrent smaller than the threshold IC 6 outputs information that no object is present. An object present within a range from a location d₁ to location d₂ can thus be detected.

In distance measuring sensor 1 of the present embodiment light receiving lens 4 and PSD 5 can have a distance therebetween adjustable to change the sensor's measurement range and distance measurement allowing range. Changing the sensor's measurement range and distance measurement allowing range, and outputting information on an object's distance for the changed measurement range as well as the changed distance measurement allowing range allows an increased distance measurement allowing range L of sensor 1. Furthermore, the distance information can be output without the necessity of driving a plurality of LEDs or PSDs separately. Information on a distance of an object can rapidly be obtained for a wide range. As a plurality of LEDs and PSDs and an IC can be dispensed with, distance measuring sensor can be configured of a reduced number of components.

### Second Embodiment

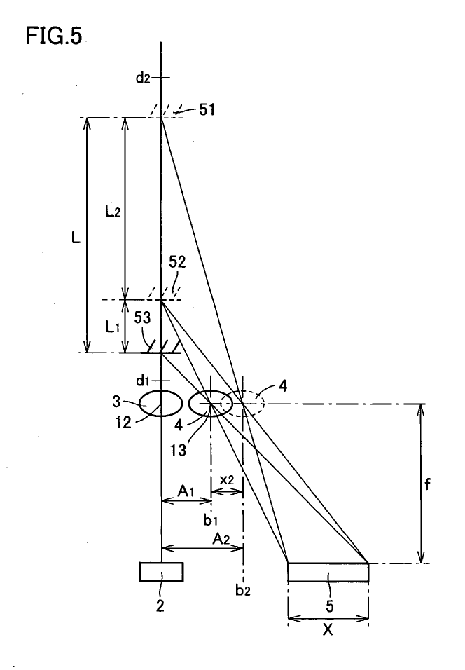

With reference to FIG. 4, the present embodiment provides distance measuring sensor 1 including light receiving lens 4 fixed to casing 7a secured to casing 7 for example by a gear (not shown). As the gear or the like rotates, casing 7a can be moved in a direction perpendicular to an optical axis (or laterally as seen in the figure) within a range x₂ with light receiving lens 4 held thereby.

The remainder of the configuration is substantially identical to that of the first embodiment shown in FIG. 1. Accordingly, like components are denoted by like reference characters and will not be described.

In the present embodiment distance measuring sensor 1 measures an object's distance in accordance with a principle as described hereinafter.

In distance measuring sensor 1 of the present embodiment projection lens 3 and light receiving lens 4 provide a baseline (a distance between an aperture 12 of projection lens 3 and an aperture 13 of light receiving lens 4) adjustable in length. More specifically, light receiving lens 4 can be moved, as seen in FIG. 5, laterally within range x₂. Accordingly, if light receiving lens 4 is located within range x₂ closest to projection lens 3, i.e., has a position b₁, the projection lens 3 and light receiving lens 4 baseline will have a length corresponding to a distance A₁. If light receiving lens 4 is located within range x₂ remotest from projection lens 3, i.e., has a position b₂, the projection lens 3 and light receiving lens 4 baseline will have a length corresponding to a distance A₂. Thus projection lens 3 and light receiving lens 4 are arranged to allow their baseline to be adjustable in length between distance A₁ and distance A₂.

More specifically, if light receiving lens 4 has position b₁, distance measuring sensor 1 has a distance measurement allowing range L₁ satisfying X=(A₁×f)/L₁, and IC 6 (FIG. 4) can output information on a distance of an object present within a range from location 52 to location 53. Furthermore, if light receiving lens 4 has position b₂ distance measuring sensor 1 has a distance measurement allowing range L₂ satisfying X=(A₂×L)/L₂, and IC 6 can output information on a distance of an object present within a range from location 51 to location 52. As such, arranging light receiving lens 4 at each of positions b₁ and b₂ an outputting an object's positional information for each position allows distance measuring sensor 1 to have a range L₁+L₂=L to provide an increased distance measurement allowing range.

For distance measuring sensor 1 of the present embodiment, positions b₁ and b₂ are determined, similarly as has been described in the first embodiment, so that a reflection of light from a single object that passes thorough lens 4 having position b₁ and that of light from the object that passes thorough lens 4 having position b₂ are not redundantly received to provide a reduced distance measurement allowing range.

In distance measuring sensor 1 of the present embodiment the projection lens 3 and light receiving lens 4 baseline can be adjusted in length to change the sensor's measurement range and distance measurement allowing range. Changing the sensor's measurement range and distance measurement allowing range, and outputting information on an object's distance for the changed measurement range as well as the changed distance measurement allowing range allows an increased distance measurement allowing range of sensor 1. Furthermore, the distance can be measured without the necessity of driving a plurality of LEDs or PSDs separately. Information on distance can rapidly be obtained for a wide range. As a plurality of LEDs and PSDs and an IC can be dispensed with, distance measuring sensor 1 can be configured of a reduced number of components.

### Third Embodiment

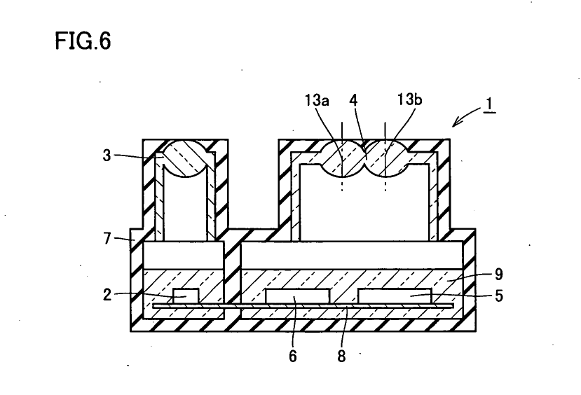

With reference to FIG. 6, the present embodiment provides distance measuring sensor 1 including light receiving lens 4 fixed to an upper right casing 7, as seen in the figure. Light receiving lens 4 has apertures 13a and 13b. In other words, light receiving lens 4 is a single lens with two different curvatures. In light receiving lens 4 apertures 13a and 13b are laterally arranged, as seen in FIG. 6.

The remainder of the configuration is substantially identical to that of the first embodiment shown in FIG. 1. Accordingly, like components are denoted by like reference characters and will not be described.

In the present embodiment distance measuring sensor 1 measures an object's distance in accordance with a principle as will be described hereinafter.

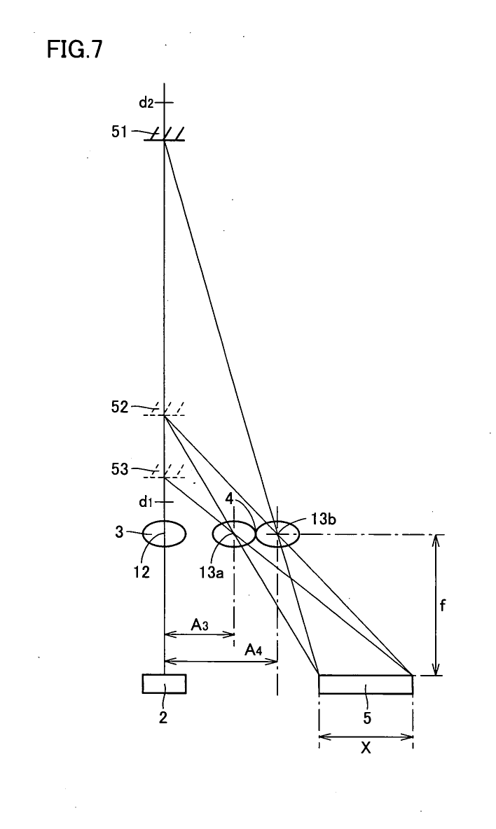

With reference to FIG. 7, light receiving lens 4 has apertures 13a and 13b arranged perpendicular to an optical axis (or laterally as seen in FIG. 7). Projection lens 3 and light receiving lens 4 at aperture 13a provide a baseline having a length A₃ (a distance between the projection lens 3 aperture 12 and the light receiving lens 4a aperture 13a) and projection lens 3 and light receiving lens 4 at aperture 13b provide a baseline having a different length A₄ (a distance between the projection lens 3 aperture 12 and the light receiving lens 4b aperture 13b).

When a reflection of light collected by light receiving lens 4 at aperture 13a is received, distance measuring sensor 1 has a distance measurement allowing range L₁ satisfying X=(A₃×f)/L₁, and IC 6 (FIG. 6) can output information on a distance of an object present within a range from location 52 to location 53. Furthermore, if a reflection of light collected by light receiving lens 4 at aperture 13a is received, distance measuring sensor 1 has a distance measurement allowing range L₂ satisfying X=(A₄×f)/L₂, and IC 6 can output information on a distance of an object present within a range from location 51 to location 52. As light collected by light receiving lens 4 at each of apertures 13a and 13b is received, distance measuring sensor 1 can provide distance measurement allowing distance L₁+L₂=L, an increased distance measurement allowing range.

In distance measuring sensor 1 of the present embodiment light receiving lens 4 has apertures 13a and 13b at a position determined similarly as has been described in the first embodiment so that a reflection of light from a single object that passes thorough aperture 13a and that of light from the object that passes thorough apertures 13b are not redundantly received to provide a reduced distance measurement allowing range.

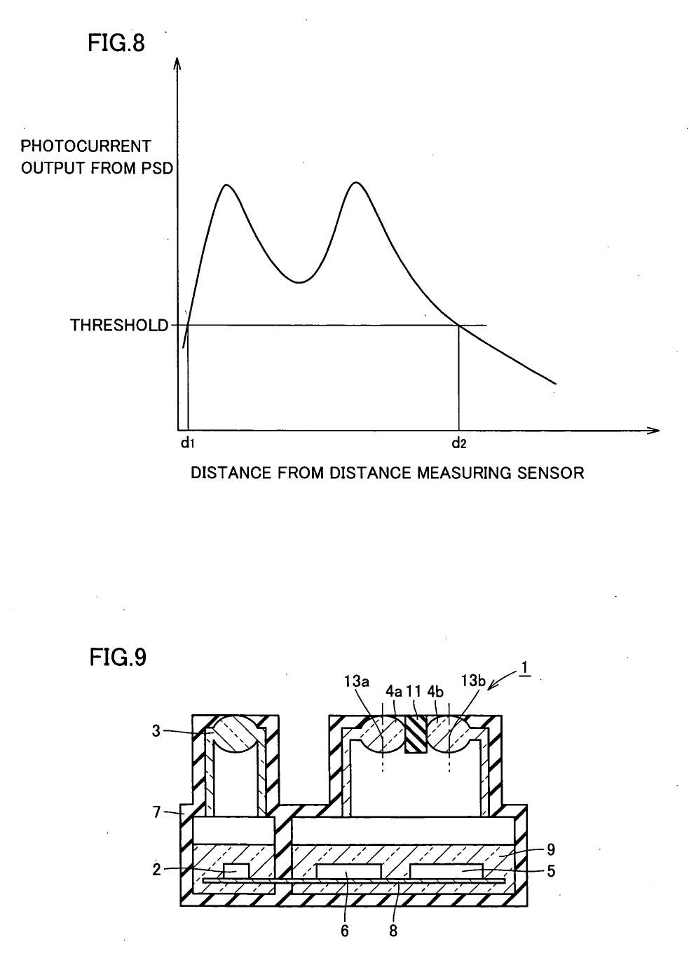

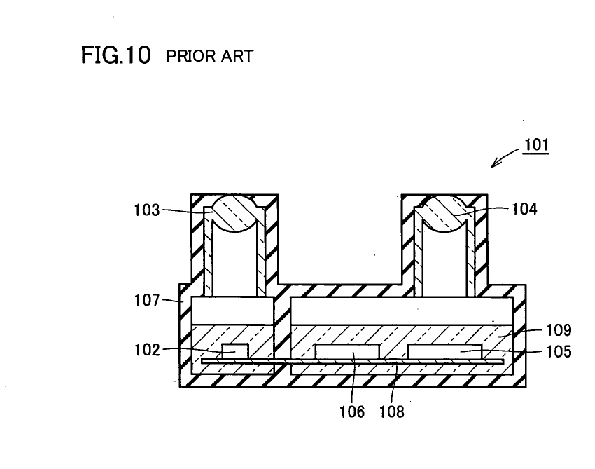

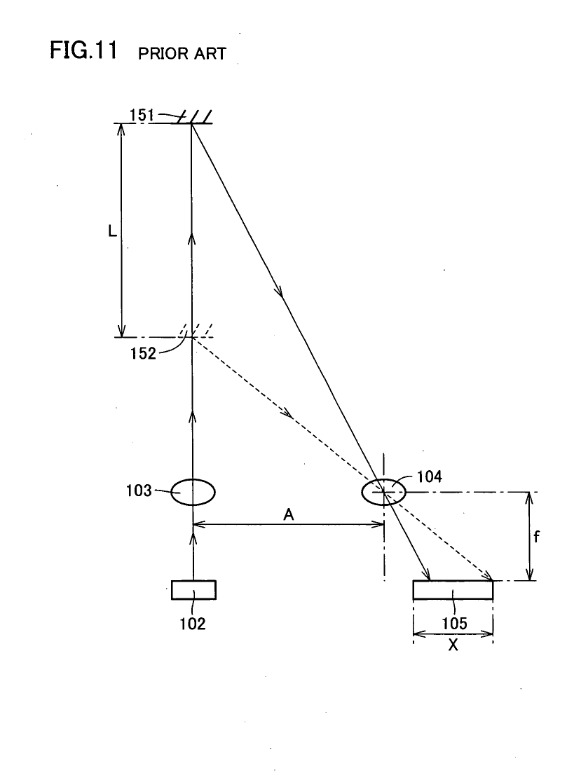

With reference to FIG. 8, as compared with the first embodiment shown in FIG. 3, the present embodiment provides distance measuring sensor 1 including a PSD 6 (FIG. 6) outputting a photocurrent corresponding to rays of light collected by light receiving lenses 4a and 4b, respectively, and simultaneously received by PSD 5. Accordingly at a portion close to sensor 1 appears a peak of an output of a photocurrent resulting from light collected by light receiving lens 4a (the left hand in FIG. 8) and at a portion remote from sensor 1 appears a peak of an output of a photocurrent resulting from light collected by light receiving lens 4b (the right hand in FIG. 8).

Such a relationship between a distance from a distance measuring sensor and a photocurrent output from a PSD can be utilized to detect for example whether an object is present or absent within a detection range. More specifically, a threshold is set for a photocurrent output from PSD 5 at one end 5a. If one end 5a outputs a photocurrent larger than the threshold IC 6 outputs information that an object is present and if one end 5a outputs a photocurrent smaller than the threshold IC 6 outputs information that no object is present. An object present within a range from a location d₁ to location d₂ can thus be detected.

In the distance measuring sensor of the present embodiment a reflection of light collected by aperture 13a and a reflection of light collected by aperture 13b are received by PSD 5. Thus information on the presence/absence of an object can be obtained for a measurement range corresponding to a measurement range associated with aperture 13a plus that associated with aperture 13b. Furthermore, measurement can be done without driving a plurality of LEDs or PSDs separately or moving light receiving lens 4. Information on a distance of an object can further rapidly be obtained for a wide range. Furthermore, a plurality of LEDs, PSDs and an IC can be dispensed with, and distance measuring sensor 1 can be formed of a reduced number of components.

In distance measuring sensor 1 of the present embodiment apertures 13a and 13b are arranged along a straight line perpendicular to an optical axis.

This can prevent light passing through aperture 13a from entering aperture 13b. This can in turn prevent light entering aperture 13a and that entering aperture 13b from interfering with each other and resulting in erroneous measurement.

While in the present embodiment apertures 13a and 13b are arranged along a straight line perpendicular to an optical axis, the present invention is not limited thereto. It only requires that light receiving lens 4 have first and second apertures, preferably arranged in a single plane perpendicular to the optical axis.

### Fourth Embodiment

With reference to FIG. 9. the present embodiment provides a distance measuring sensor 1 including two light receiving lenses 4a and 4b laterally arranged, as seen in the figure. Light receiving lenses 4a and 4b have apertures 13a and 13b, respectively, with a shading member 11 arranged therebetween.

The remainder of the configuration and its principle applied to measure a distance of an object are substantially identical to those described in the third embodiment with reference to FIG. 6. Accordingly, like components are denoted by like reference characters and will not be described.

In the present embodiment distance measuring sensor 1 includes light receiving lens 4a having aperture 13a and light receiving lens 4b having aperture 13b.

As apertures 13a and 13b are configured by separate lenses, light having entered aperture 13a can be prevented from leaking and interfering with that having entered aperture 13b (or producing stray light).

In the present embodiment distance measuring sensor 1 further includes shading member 11 arranged between apertures 13a and 13b.

Shading member 11 isolates light having entered aperture 13a and that having entered aperture 13b. The light having entered aperture 13a can further be prevented from leaking and interfering with that having entered aperture 13b (or producing stray light).

The distance measuring sensor as described in the first to fourth embodiments can be mounted in electronics. In the electronics information on a distance of an object can rapidly be output for a wide range. Furthermore the electronics can be formed of a reduced number of components.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A distance measuring sensor comprising:
a light emitting device;
a projection lens receiving light emitted from said light emitting device to direct the light to illuminate an object;
a light receiving lens collecting light reflected by said object; and
a photoreceptive device receiving at a location light collected by said light receiving lens to output a signal corresponding to said location, said light receiving lens and said photoreceptive device being configured to have an adjustable distance therebetween, as seen along an optical axis from said light receiving lens to said photoreceptive device.

2. Electronics equipped with the distance measuring sensor of claim 1.

3. A distance measuring sensor comprising:
a light emitting device;
a projection lens receiving light emitted from said light emitting device to direct the light to illuminate an object;
a light receiving lens collecting light reflected by said object; and
a photoreceptive device receiving at a location light collected by said light receiving lens to output a signal corresponding to said location, said projection leans and said light receiving lens being configured to provide a baseline adjustable in length.

4. Electronics equipped with the distance measuring sensor of claim 3.

5. A distance measuring sensor comprising:
a light emitting device;
a projection lens receiving light emitted from said light emitting device to direct the light to illuminate an object;
a light receiving lens collecting light reflected by said object; and
a photoreceptive device receiving at a location light collected by said light receiving lens to output a signal corresponding to said location, said light receiving lens having first and second apertures.

6. Electronics equipped with the distance measuring sensor of claim 5.

7. The sensor of claim 5, wherein said first and second apertures are arranged in a single plane perpendicular to an optical axis.

8. The sensor of claim 5, wherein said light receiving lens includes a first light receiving lens having said first aperture and a second light receiving lens having said second aperture.

9. The sensor of claim 8, further comprising a shading member arranged between said first and second apertures.
